(19) United States
(12) Patent Application Publication
(10) Pub. No.: US 2024/0386159 A1
(43) Pub. Date: Nov. 21, 2024

(54) ELECTRIC POWER STABILITY CONTROL SIMULATION MODEL CONSTRUCTION METHOD AND APPARATUS, AND ELECTRIC POWER STABILITY CONTROL SIMULATION SYSTEM

(71) Applicant: ELECTRIC POWER RESEARCH INSTITUTE, CHINA SOUTHERN POWER GRID, Guangzhou, Guangdong (CN)

(72) Inventors: Yihua ZHU, Guangzhou, Guangdong (CN); Qi GUO, Guangzhou, Guangdong (CN); Dongxu CHANG, Guangzhou, Guangdong (CN); Binjiang HU, Guangzhou, Guangdong (CN); Mingkang WU, Guangzhou, Guangdong (CN); Jie ZHANG, Guangzhou, Guangdong (CN); Yukun ZHU, Guangzhou, Guangdong (CN); Chengxiang LI, Guangzhou, Guangdong (CN); Hengdao GUO, Guangzhou, Guangdong (CN)

(73) Assignee: ELECTRIC POWER RESEARCH INSTITUTE, CHINA SOUTHERN POWER GRID, Guangzhou, Guangdong (CN)

(21) Appl. No.: 18/577,241

(22) PCT Filed: May 10, 2022
(86) PCT No.: PCT/CN2022/092011

§ 371 Date: Jan. 6, 2024

(30) Foreign Application Priority Data
Sep. 22, 2021 (CN) 202111107586.8

(51) Int. Cl. G06F 30/20

(52) U.S. Cl. CPC G06F 30/20

(57) ABSTRACT

An electric power stability control simulation model construction method and apparatus, and an electric power stability control simulation system. According to an external interface function extracted from a stability control device program, a corresponding callback interface function is generated by using the external interface function, and an electric power stability control simulation model is constructed by means of the callback interface function in combination with the correspondence between the callback interface function and the external interface function. When the electric power stability control simulation model is executed to perform a simulation test, the corresponding external interface function can be called by means of the callback interface function, so that the function simulation of the corresponding stability control device program can be realized.

This application claims the benefit of Chinese Patent Application No. 202111107586.8, entitled “METHOD AND DEVICE FOR CONSTRUCTING POWER STABILITY CONTROL SIMULATION MODEL, AND SIMULATION SYSTEM”, filed on Sep. 22, 2021 with the China National Intellectual Property Administration, which is incorporated herein by reference in its entirety.

### FIELD

The present disclosure relates to the technical technology of big data, and in particular to a method and a device for constructing a power stability control simulation model, and a simulation system.

### BACKGROUND

With the continuous increase of electricity consumption in China, three defense lines for security and stability of power systems have been proposed to ensure safe operations of power grids. Since the implementation of asynchronous interconnection in the power systems, significant changes have occurred in the structure and operational features of the power grids. Coordination control of the second and the third defense lines for the power systems is particularly important for safe and stable operations of the power grids.

Currently, constructing a simulation model for simulating the power system to research actions of the second and the third defense lines is one of the most commonly used research approaches. For simulation, a stability control device program is ported from an embedded device to a personal computer (PC), and then an interface program is programed to construct a virtual device simulation model. However, the model constructed in this way has unstable simulation accuracy.

### SUMMARY

A method and a device for constructing a power stability control simulation model, and a simulation system are provided according to the present disclosure, to solve the technical problem of unstable simulation accuracy of a model constructed using the conventional technology.

A method for constructing a power stability control simulation model is provided in a first aspect of the present disclosure. The method includes: obtaining a stability control device program of an actual stability control device; extracting an external interface function in the stability control device program; generating a callback interface function based on the external interface function, where the callback interface function is a callback function that takes the external interface function as a transfer parameter; and constructing a power stability control simulation model based on the callback interface function in combination with a correspondence between the callback interface function and the external interface function, to implement simulation for a power system using the power stability control simulation model.

Preferably, the external interface function includes an analog signal input/output interface, a digital signal input/output interface, and a communication channel data input/output interface.

Preferably, the analog signal input/output interface includes: a master-slave communication analog signal input/output interface and an interstation communication analog signal input/output interface.

Preferably, the digital signal input/output interface includes: a master-slave communication digital signal input/output interface and an interstation communication digital signal input/output interface.

Preferably, the communication channel data input/output interface includes: a master-slave communication channel data input/output interface and an interstation communication channel data input/output interface.

A device for constructing a power stability control simulation model is provided in a second aspect of the present disclosure. The device includes a stability control program obtaining unit, an interface function extraction unit, a callback interface function generation unit, and a simulation model construction unit. The stability control program obtaining unit is configured to obtain a stability control device program of an actual stability control device. The interface function extraction unit is configured to extract an external interface function in the stability control device program. The callback interface function generation unit is configured to generate a callback interface function based on the external interface function, where the callback interface function is a callback function that takes the external interface function as a transfer parameter. The simulation model construction unit is configured to construct a power stability control simulation model based on the callback interface function in combination with a correspondence between the callback interface function and the external interface function, to implement simulation for a power system using the power stability control simulation model.

Preferably, the external interface function includes an analog signal input/output interface, a digital signal input/output interface, and a communication channel data input/output interface.

Preferably, the analog signal input/output interface includes: a master-slave communication analog signal input/output interface and an interstation communication analog signal input/output interface. The digital signal input/output interface includes: a master-slave communication digital signal input/output interface and an interstation communication digital signal input/output interface. The communication channel data input/output interface includes: a master-slave communication channel data input/output interface and an interstation communication channel data input/output interface.

A power stability control simulation system is provided in a third aspect of the present disclosure. The power stability control simulation system includes an actual stability control device, an upper computer, and a simulation testing device. The actual stability control device, the upper computer, and the simulation testing device are sequentially in communication connection. The upper computer includes the device for constructing a power stability control simulation model according to the second aspect of the present disclosure. The simulation testing device is configured to communicate with a power stability control simulation model constructed by the upper computer to implement simulation for a power system.

Preferably, the simulation testing device includes: a PSAPS simulation testing device or an RTDS simulation testing device.

It can be seen from the above technical solutions that the present disclosure has the following advantages.

The method for constructing a power stability control simulation model according to the present disclosure includes: obtaining a stability control device program of an actual stability control device; extracting an external interface function in the stability control device program; generating a callback interface function based on the external interface function, where the callback interface function is a callback function that takes the external interface function as a transfer parameter; and constructing a power stability control simulation model based on the callback interface function in combination with a correspondence between the callback interface function and the external interface function, to implement simulation for a power system using the power stability control simulation model.

In the present disclosure, the external interface function is extracted from the stability control device program, and a corresponding callback interface function is generated based on the external interface function. The power stability control simulation model is constructed based on the callback interface function in combination with a correspondence between the callback interface function and the external interface function. When the electric power stability control simulation model is executed to perform a simulation test, the corresponding external interface function can be called by means of the callback interface function, so that the function simulation of the corresponding stability control device program can be realized. In the process of constructing the power stability control simulation model, programming and adjustment of the ported interface function are reduced, and a simulation result of the constructed power stability control simulation model is close to an operation result of actual hardware and the simulation result is stable.

### BRIEF DESCRIPTION OF THE DRAWINGS

In order to more clearly describe technical solutions in the embodiments of the present disclosure or in the conventional technology, drawings to be used in the description of the embodiments or the conventional technology are briefly introduced hereinafter. It is apparent that the drawings described below show merely the embodiments of the present disclosure, and those skilled in the art may obtain other drawings based on the provided drawings without any creative effort.

FIG. 1 is a flowchart of a method for constructing a power stability control simulation model according to an embodiment of the present disclosure; and

FIG. 2 is a schematic structural diagram of a device for constructing a power

stability control simulation model according to an embodiment of the present disclosure.

### DETAILED DESCRIPTION OF THE EMBODIMENTS

Since the implementation of asynchronous interconnection in power systems, significant changes have occurred in the structure and operational features of the Southern Power Grid in China. The coordination control of the second and third defense lines for the power system is particularly important for the safe and stable operation of the power grid. However, there is currently a lack of approaches to perform comprehensive simulation calculation and verification on the scheme of controlling the second and third defense lines at an overall level, which are capable of accurately simulating actions of the second and third defense lines after a fault occurs and providing simulation result reflecting the actual system.

So far, most relevant researches are limited to the application of dispatcher training simulators (DTS) or modeling of relay protection devices for the first defense line. Due to real-time constraints, the constructed model is usually rough and has simulation result differing significantly from an actual condition. In commonly used power system simulation programs such as PSS/E, EUROSTAG and NETOMAC, although some simple SPS models are provided, the models are based on prototypes from foreign countries and differ significantly from the actual situation in domestic power systems of China, and cannot reflect the operational features of the security and stability control devices in the Southern Power Grid of China. Therefore, the development of accurate real-time simulation models for the second and third defense lines and application of the models in the simulation analysis and control research of the Southern Power Grid become increasingly urgent.

Currently, constructing a simulation model for simulating the power system to research actions of the second and the third defense lines is one of the most commonly used research approaches. For simulation, a stability control program is ported from an embedded device to a personal computer (PC), and then an interface program is programed to construct a virtual device simulation model. Through researches, it is found that the above problem is resulted from the following reasons. Although some simple SPS models are provided in existing power system simulation programs such as PSS/E, EUROSTAG and NETOMAC, the models are based on prototypes from foreign countries and differ significantly from the actual situation of domestic power systems in China. In addition, levels of technical personnel writing interface programs vary greatly, resulting unstable difference between a constructed power stability control simulation model and an actual power system in terms of the stability control result.

A method and a device for constructing a power stability control simulation model, and a simulation system are provided according to the embodiments of the present disclosure, to solve the technical problem of unstable simulation accuracy of a model constructed using the conventional technology.

In order to make the objectives, features, and advantages of the present disclosure clearer and more comprehensible, the technical solutions in the embodiments of the present disclosure are described below with reference to the drawings in the embodiments of the present disclosure. Apparently, the embodiments described below are merely a part rather than all of the embodiments of the present disclosure. All the other embodiments obtained by those skilled in the art based on the embodiments in the present disclosure without any creative work fall into the protection scope of the present disclosure.

A power stability control simulation system according to the present disclosure includes an actual stability control device, an upper computer, and a simulation testing device.

The actual stability control device, the upper computer, and the simulation testing device are sequentially in communication connection.

The upper computer is configured to implement the method for constructing a power stability control simulation model according to the present disclosure, so as to construct a power stability control simulation model.

The simulation testing device is configured to communicate with the power stability control simulation model constructed by the upper computer to implement simulation for a power system.

Furthermore, the simulation testing device includes: a PSAPS simulation testing device or an RTDS simulation testing device.

By using the power stability control simulation system according to this embodiment, the difficulty in virtualization of an external interface of the stability control device after the stability control device program is ported from the embedded device to the upper computer (for example, personal computer) is solved. The stability control device subjected to virtualization interfaces a virtual simulation platform of the stability control system, and exchanges information, through the virtual simulation platform of the stability control system, with the simulation testing software (systems) such as PSAPS and RTDS in real time. A logic strategy function of the actual stability control system is dynamically simulated, so as to achieve quasi real-time closed-loop simulation testing of the stability control system.

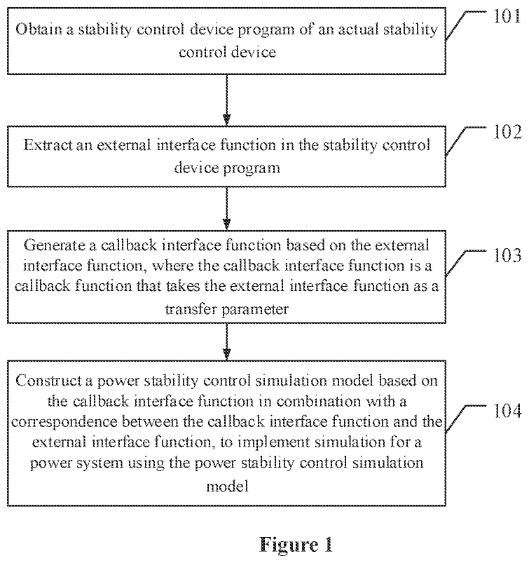

Referring to FIG. 1, a method for constructing a power stability control simulation model according to this embodiment includes the following steps S101 to S104.

In step 101, a stability control device program of an actual stability control device is obtained.

In step 102, an external interface function in the stability control device program is extracted.

In step 103, a callback interface function is generated based on the external interface function, where the callback interface function is a callback function that takes the external interface function as a transfer parameter.

In step 104, the power stability control simulation model is constructed based on the callback interface function in combination with a correspondence between the callback interface function and the external interface function, to implement simulation for a power system using the power stability control simulation model.

It should be noted that in the present disclosure, the external interface function is extracted from the stability control device program and the callback interface function is generated based on the external interface function, to virtualize the external interface function of the stability control device program. The callback interface function is associated with the interface of the virtual simulation platform of the stability control system based on the callback interface function in combination with a the correspondence between the callback interface function and the external interface function, so as to construct the power stability control simulation model. Furthermore, the power stability control simulation model exchanges information with the simulation testing software (systems) such as PSAPS and RTDS in real time, and the logic strategy function of the actual stability control system is dynamically simulated, so as to achieve quasi real-time closed-loop simulation testing of the stability control system. In the simulation testing, the power stability control simulation model simply calls a corresponding external interface function through the callback interface function to simulate a function of a corresponding stability control device program. In this way, problems such as human mistakes caused by programming the interface function can be avoided. A simulation result of the constructed power stability control simulation model is close to an operation result of actual hardware and the simulation result is stable. When performing consistency comparison between a stability control virtual simulation system implemented by the method according to the present disclosure and an actual hardware system based on a same primary system model, the following indicators are met: 1) consistency of stability control strategy actions: the two systems have the same strategy actions and consistent control objects; 2) consistency of implementation of the stability control strategy: a machine shedding error between the two systems does not exceed one unit, and a load shedding error does not exceed 100 MW; and 3) consistency of an overall action time of the stability control strategy: a difference in overall action time of the control strategy without delay between the two systems does not exceed 20 ms, and an overall action time of an overload strategy does not exceed 0.5 s.

Details of the first embodiment of the method for constructing a power stability control simulation model according to the present disclosure are described above, and details of second embodiment of the method for constructing a power stability control simulation model according to the present disclosure are described below.

As shown in FIG. 1, a method for constructing a power stability control simulation model is provided according to this embodiment based on the content of the first embodiment.

The external interface function in the first embodiment includes: an analog signal input/output interface, a digital signal input/output interface, and a communication channel data input/output interface.

The above three external interfaces may be divided, based on service functions, into two categories: master-slave communication interface and interstation communication interface The master-slave communication interface includes: a master-slave communication analog signal input/output interface, a master-slave communication digital signal input/output interface, and a master-slave communication channel data input/output interface. The interstation communication interface includes: an interstation communication analog signal input/output interface, an interstation communication digital signal input/output interface, and an interstation communication channel data input/output interface.

It should be noted that for the master-slave communication interface: due to large amount and uncertainty of spaced information inputted to the stability control device, the stability control device generally adopts a master-slave distributed architecture to adapt to actual situations of different control and protection rooms. A single device consists of one master and several slaves A private communication protocol of a manufacturer is usually used between the stability control master and the stability control slaves. The analog signal input, and the digital signal input/output of the stability control device are configured on the slaves, and information exchange is performed between the stability control master and the stability control slaves through a master-slave protocol. For the interstation communication interface: interstation communication of the stability control system is performed mainly using a 2 Mbps dedicated fiber optic channel and a 2 Mbps fiber optic multiplexing channel. The communication between various stations is performed by using a point-to-point high-level data link control (HDLC) protocol for transparent transmission. These two types of external interfaces exhibit a one-to-multiple entity dependency relationship. That is, one stability control master corresponds to multiple stability control slaves, or one stability control site communicates with multiple stability control sites. In order to improve the scalability and maintainability of virtualization of such interfaces, an abstract oriented approach is adopted in which the external interface of the stability control device is designed as a callback function. In this way, loose coupling logical relationships can be established between the virtual stability control devices, which can effectively reduce a degree of coupling during the virtualization of the external interface of the stability control device and improve the maintainability and scalability of the virtual stability control devices. When communication content or communication topology changes, new functionality can be extended by simply implementing interfaces or inheriting abstract classes.

Examples of the data interface functions used in the embodiments of the present disclosure are described as follows.
1. Master-slave communication interface
1) Interface for the device to obtain data
a) Definition of type of the callback function

typedef Uint8 (*DATA_HANDLER) (Uint16 master no, Uint8 slave_no, Uint16*const data, Uint8 data_num);

### Definition of Data Interface Callback Function

| variable | meaning | remarks |
|---|---|---|
| return value Uint8 | 1: indicates success | |
| | 0: indicates failure | |
| master_no | numbering of master | value of master_no |
| | | sent by |
| | | returning platform |
| slave_no | numbering of slave | 0 indicates invalid |
| Uint16*const data | header address of master-slave | |
| | communication interaction | |
| Uint8 data_num | maximum index of data field | 0 indicates invalid |
| | for master-slave | |
| | communication interaction | |

b) Input the callback function
void data_register (DATA_HANDLER data_handler);

Description: data_register is implemented by a dynamic library of the device, and the platform calls the dynamic library to register a data reading function handle for the device first through data_register.

### Definitions of Master-Slave Communication Data

| serial | | |
|---|---|---|
| number | meaning | explanation |
| 0. | flag of starting of | BIT0: Unit 1 starts BIT1: Unit 2 starts |
| | slave | BIT2: Unit 3 starts BIT3: Unit 4 starts |
| | | BIT4: Unit 5 starts BIT5: Unit 6 starts |
| | | BIT8: starting at a low frequency |
| | | BIT9: starting at a low voltage |
| | | BIT10: starting at an over frequency |
| | | BIT15: flag of total starting |
| | | (starting of any unit) |
| 1. | flag of slave action | |
| | at a low frequency | |
| 2. | flag of slave action | |
| | at a low voltage | |
| 3. | flag of slave action | |
| | at an over | |
| | frequency | |
| 4. | digital signal 1 to | |
| | 16 of slave | |
| | digital signal 17 to | |
| | 32 of slave | |
| 6. | digital signal 33 to | |
| | 48 of slave | |
| 7. | state information of | BIT0: put into operation |
| | Unit 1 | BIT1: PT disconnection |
| | | BIT2: CT disconnection |
| | | BIT3: abnormal position signal |
| | | BIT4: abnormal tripping signal |
| | | BIT10 instantaneous PT disconnection |
| | | BIT11: instantaneous CT disconnection |
| 8. | action information | BIT0: single instantaneous fault |
| | of Unit 1 | BIT1: single permanent fault |
| | | BIT2: interphase fault |
| | | BIT3: three phase fault |
| | | BIT4: fault-free tripping |
| 9. | analog signal 1 of | Ua |
| | Unit 1 | |
| 10. | analog signal 2 of | Ub |
| | Unit 1 | |
| 11. | analog signal 3 of | Uc |
| | Unit 1 | |
| 12. | analog signal 4 of | Ia |
| | Unit 1 | |
| 13. | analog signal 5 of | Ib |
| | Unit 1 | |
| 14. | analog signal 6 of | Ic |
| | Unit 1 | |
| 15. | analog signal 7 of | P |
| | Unit 1 | |
| 16. | analog signal 8 of | Q |
| | Unit 1 | |
| 17. | analog signal 9 of | 3U0 |
| | Unit 1 | |
| 18. | analog signal 10 of | 3I0 |
| | Unit 1 | |
| 19. | analog signal 11 of | U1 |
| | Unit 1 | |
| 20. | state information of | BIT0: put into operation |
| | Unit 2 | BIT1: PT disconnection |
| | | BIT2: CT disconnection |
| | | BIT3: abnormal position signal |
| | | BIT4: abnormal tripping signal |
| | | BIT10 instantaneous PT disconnection |
| | | BIT11: instantaneous CT disconnection |
| 21. | action information | BIT0: single instantaneous fault |
| | of Unit 2 | BIT1: single permanent fault |
| | | BIT2: interphase fault |
| | | BIT3: three phase fault |
| | | BIT4: fault free tripping |
| 22. | analog signal 1 of | Ua |
| | Unit 2 | |
| 23. | analog signal 2 of | Ub |
| | Unit 2 | |
| 24. | analog signal 3 of | Uc |
| | Unit 2 | |
| 25. | analog signal 4 of | Ia |
| | Unit 2 | |
| 26 | analog signal 5 of | Ib |
| | Unit 2 | |
| 27. | analog signal 6 of | Ic |
| | Unit 2 | |
| 28. | analog signal 7 of | P |
| | Unit 2 | |
| 29. | analog signal 8 of | Q |
| | Unit 2 | |
| 30 | analog signal 9 of | 3U0 |
| | Unit 2 | |
| 31. | analog signal 10 of | 3I0 |
| | Unit 2 | |
| 32. | analog signal 11 of | U1 |
| | Unit 2 | |
| 33. | state information of | BIT0: put into operation |
| | Unit 3 | BIT1: PT disconnection |
| | | BIT2: CT disconnection |
| | | BIT3: abnormal position signal |
| | | BIT4: abnormal tripping signal |
| | | BIT10 instantaneous PT disconnection |
| | | BIT11: instantaneous CT disconnection |
| 34. | action information | BIT0: single instantaneous fault |
| | of Unit 3 | BIT1: single permanent Fault |
| | | BIT2: interphase fault |
| | | BIT3: three phase fault |
| | | BIT4: fault free tripping |
| 35. | analog signal 1 of | Ua |
| | Unit 3 | |
| 36. | analog signal 2 of | Ub |
| | Unit 3 | |
| 37. | analog signal 3 of | Uc |
| | Unit 3 | |
| 38. | analog signal 4 of | Ia |
| | Unit 3 | |
| 39. | analog signal 5 of | Ib |
| | Unit 3 | |
| 40. | analog signal 6 of | Ic |
| | Unit 3 | |
| 41. | analog signal 7 of | P |
| | Unit 3 | |
| 42. | analog signal 8 of | Q |
| | Unit 3 | |
| 43. | analog signal 9 of | 300 |
| | Unit 3 | |
| 44. | analog signal 10 of | 3I0 |
| | Unit 3 | |
| 45. | analog signal 11 of | UI |
| | Unit 3 | |
| 46. | state information of | BIT0: put into operation |
| | Unit 4 | BIT1: PT disconnection |
| | | BIT2: CT disconnection |
| | | BIT3: abnormal position signal |
| | | BIT4: abnormal tripping signal |
| | | BIT10 instantaneous PT disconnection |
| | | BIT11: instantaneous CT disconnection |
| 47. | action information | BIT0: single instantaneous fault |
| | of Unit 4 | BIT1: single permanent fault |
| | | BIT2: interphase fault |
| | | BIT3: three phase fault |
| | | BIT4: fault free tripping |
| 48. | analog signal 1 of | Ua |
| | Unit 4 | |
| 49. | analog signal 2 of | Ub |
| | Unit 4 | |
| 50. | analog signal 3 of | Uc |
| | Unit 4 | |
| 51. | analog signal 4 of | Ia |
| | Unit 4 | |
| 52. | analog signal 5 of | Ib |
| | Unit 4 | |
| 53. | analog signal 6 of | Ic |
| | Unit 4 | |
| 54. | analog signal 7 of | P |
| | Unit 4 | |
| 55. | analog signal 8 of | Q |
| | Unit 4 | |
| 56. | analog signal 9 of | 3U0 |
| | Unit 4 | |
| 57. | analog signal 10 of | 3I0 |
| | Unit 4 | |
| 58. | analog signal 11 of | U1 |
| | Unit 4 | |
| 59. | state information of | BIT0: put into operation |
| | Unit 5 | BIT1: PT disconnection |
| | | BIT2: CT disconnection |
| | | BIT3: abnormal position signal |
| | | BIT4: abnormal tripping signal |
| | | BIT10 instantaneous PT disconnection |
| | | BIT11: instantaneous CT disconnection |
| 60. | action information | BIT0: single instantaneous fault |
| | of Unit 5 | BIT1: single permanent fault |
| | | BIT2: interphase fault |
| | | BIT3: three phase fault |
| | | BIT4: fault free tripping |
| 61. | analog signal 1 of | Ua |
| | Unit 5 | |
| 62. | analog signal 2 of | Ub |
| | Unit 5 | |
| 63. | analog signal 3 of | Uc |
| | Unit 5 | |
| 64. | analog signal 4 of | Ia |
| | Unit 5 | |
| 65. | analog signal 5 of | Ib |
| | Unit 5 | |
| 66. | analog signal 6 of | Ic |
| | Unit 5 | |
| 67. | analog signal 7 of | P |
| | Unit 5 | |
| 68. | analog signal 8 of | Q |
| | Unit 5 | |
| 69. | analog signal 9 of | 3U0 |
| | Unit 5 | |
| 70. | analog signal 10 of | 3I0 |
| | Unit 5 | |
| 71. | analog signal 11 of | U1 |
| | Unit 5 | |
| 72. | state information of | BIT0: put into operation |
| | Unit 6 | BIT1: PT disconnection |
| | | BIT2; CT disconnection |
| | | BIT3: abnormal position signal |
| | | BIT4: abnormal tripping signal |
| | | BIT10 instantaneous PT disconnection |
| | | BIT11: instantaneous CT disconnection |
| 73. | action information | BIT0: single instantaneous fault |
| | of Unit 6 | BIT1: single permanent fault |
| | | BIT2: interphase fault |
| | | BIT3: three phase fault |
| | | BIT4: fault free tripping |
| 74. | analog signal 1 of | Ua |
| | Unit 6 | |
| 75. | analog signal 2 of | Ub |
| | Unit 6 | |
| 76. | analog signal 3 of | Uc |
| | Unit 6 | |
| 77. | analog signal 4 of | Ia |
| | Unit 6 | |
| 78. | analog signal 5 of | Ib |
| | Unit 6 | |
| 79. | analog signal 6 of | Ic |
| | Unit 6 | |
| 80. | analog signal 7 of | P |
| | Unit 6 | |
| 81. | analog signal 8 of | Q |
| | Unit 6 | |
| 82. | analog signal 9 of | 3U0 |
| | Unit 6 | |
| 83. | analog signal 10 of | 3I0 |
| | Unit 6 | |
| 84. | analog signal 11 of | U1 |
| | Unit 6 | |
| 85. | Comprehensive | |
| | frequency | |
| 86. | frequency of Unit 1 | |
| 87. | frequency of Unit 2 | |
| 88. | frequency of Unit 3 | |
| 89. | frequency of Unit 4 | |
| 90. | frequency of Unit 5 | |
| 91. | frequency of Unit 6 | |

2) Interface for the device to send data
a) Definition of type of the callback function
Uint8 getSlaveOutput (Uint8 slave_no, Uint32*data);

### Definitions of Data of the Callback Function for Data-Sending of the Device

| variable | meaning | remarks |
|---|---|---|
| slave_no | numbering of slave | 0 indicates invalid |
| Uint32*data | header address of master-slave | |
| | communication interaction | |

Sequence of slave outlets is defined as shown in the table below.

### Definitions of Data of Slave Outlets

| serial number | meaning | explanation |
|---|---|---|
| 0. | slave outlet matrix 1 | outlets 1 to 16 |
| 1. | slave outlet matrix 2 | outlets 17 to 32 |

2. Fixed values, and plate interfaces
a) Modify fixed values for the master and the slaves and obtain interfaces
Uint8 setMasterSetting (Uint16 setting_no, float setting_value);
Uint8 getMasterSetting (Uint16 setting_no, float*setting_value);
Uint8 setSlaveSetting (Uint16 setting_no, float setting_value);
Uint8 getSlaveSetting (Uint16 settin_no, float*settin_value);

### Setting Modification and Obtaining Function Definition for the Master and the Slaves

| variable | meaning | remarks |
|---|---|---|
| setting_no | numbering of fixed value | 0 indicates invalid |
| setting_value | size of fixed value | |
| | return value: | |
| | 1: succeed in setting | |
| | 0: fail in setting | |

Description: setMasterSetting/getMasterSetting is implemented by the dynamic library of the device and the interfaces are open for the platform to call.
b) Put a functional plate of the master into operation and out of operation and obtain interfaces
Uint8 setMasterBI(Uint8 bi_no, Uint8 val);
Uint8 getMasterBI(Uint8 bi_no, Uint8*val);

### Definitions of Putting Functional Plate of the Master Into Operation and Out of Operation and Obtaining Interfaces

| variable | meaning | remarks |
|---|---|---|
| bi_no | numbering of binary input | 0 indicates invalid |
| val | setting value of binary input | 0 indicates putting out of |
| | | operation, non 0 indicates |
| | | putting into operation |
| | return value: | |
| | 1: succeed in setting | |
| | 0: fail in setting | |

Description: setMasterBI/getMasterBI is implemented by the dynamic library of the device and the interfaces are open for the platform to call.
3. Interstation communication interface
1) Callback function for sending and receiving interstation data
a) Definition of type of the callback function
typedef Uint8 (*COMM_HANDLER)(Uint16 master_no, Uint16*data, Uint8 data_num, Uint8 chan_no);

### Definition of Callback Function for Receiving Interstation Data

| variable | meaning | remarks |
|---|---|---|
| return value Uint8 | 0: indicates failure | |
| | 1: indicates success | |
| Uint16 master_no | numbering of master | value of master_no |
| | | sent by returning |
| | | platform |
| Uint16*data | first address of cache for | |
| | interstation communication | |
| | content | |
| Uint8 data_num | size of cache for | unit is word, |
| | communication content | Uint16 |
| Uint8 chan_no | numbering of channel for | 0 indicates invalid |
| | interstation communication | |

b) Callback function for receiving data
void comm_rcv_register(COMM_RCV_HANDLER comm_rcv_handler);

Description: comm_rev_register is implemented by the dynamic library of the device, and the platform calls the dynamic library to register a simulation platform communication data reception callback interface for the device first through comm_register. During calculation, the device obtains sending data of a specified interstation channel according to the callback function.
c) Callback function for sending data
void comm_send_register(COMM_HANDLER comm_handler);

Description: comm_send_register is implemented by the dynamic library of the device, and the platform calls the dynamic library to register a simulation platform communication data sending callback interface for the device first through comm_send_register. During calculation, the device obtains sending data of a specified interstation channel according to the callback function.

Definitions of formats of interstation communication are as shown in the table below.

### Definitions of Data Formats of Interstation Communication

| serial | | |
|---|---|---|
| number | meaning | explanation |
| 0. | Flag Warn | non 0 indicates channel alarm |
| 1. | FlagCheck | BIT0: channel exit |
| | | BIT1: channel self-loop |
| | | BIT2: command frame |
| | | BIT3: new data frame |
| 2. | communication data 1 | |
| 3. | communication data 2 | |
| 4. | communication data 3 | |
| 5. | communication data 4 | |
| 6. | communication data 5 | |
| 7. | communication data 6 | |
| 8. | communication data 7 | |
| 9. | communication data 8 | |
| 10. | communication data 9 | |
| 11. | communication data 10 | |
| 12 | communication data 11 | |
| 13. | communication data 12 | |

2) Obtain/Set a channel communication address
Uint8 getCommChanAddr (Uint8 chan_no);

### Definition of Channel Address Obtaining Function

| variable | meaning | remarks |
|---|---|---|
| return value: Uint8 | The set address of the channel | |

Uint8 setCommChanAddr (Uint8 chan_no, Uint8 addr);

### Definition of Channel Address Setting Function

| variable | meaning | remarks |
|---|---|---|
| return value: Uint8 | 0: failure | |
| | 1: success | |
| chan_no | numbering of channel, refer to xml | |
| | configuration file for associated | |
| | factory and station | |
| addr | fixed value required set for | |
| | communication address | |

3) Obtain a maximum channel number
Uint8 getMaxChanNum( );

### Definition of Maximum-Channel-Number Obtaining Function

| variable | meaning | remarks |
|---|---|---|
| return value: Uint8 | maximum number of | |
| | communication channels | |

4. Action report and fault information interface
1) Action-report calling interface
Uint16 get TripReferTable(ReportItem*output);

### Definition of Action-Report Calling Function

| variable | meaning | remarks |
|---|---|---|
| output | header address of action-report | NULL indicates |
| | reference table data returned | invalid |
| | by the device | |
| | return value: the number of action | |
| | messages | |
| | 0: No action report | |

Description: getTripReferTable is implemented by the dynamic library of the device, and interfaces are open for the platform to call. The device interface function performs data backfill based on the first address provided by the platform.
2) Fault-information calling interface
Uint16 getFaultInfoReferTable (ReportItem*output);

### Definition of Fault-Information Calling Function

| variable | meaning | remarks |
|---|---|---|
| output | header address of fault | NULL indicates |
| | information reference table data | invalid |
| | returned by the device | |
| | return value: the number of | |
| | pieces of fault information | |
| | 0: no fault information | |

Description: getFaultInfoReferTable is implemented by the dynamic library of the device, and interfaces are open for the platform to call. The device interface function performs data backfill based on the first address provided by the platform.
5. Process control
1) Instantiate a calculation unit of the device
Uint8 newDevice( )

### Definition of Calculation-Unit Instantiation Function

| variable | meaning | remarks |
|---|---|---|
| | return value: whether instantiation is | |
| | successful | |
| | 0: fail in initialization | |
| | 1: succeed in initialization | |

2) Set instantiation numbering of the stability control device
void set_master_no(Uint16 master_no);

### Definition of Function for Setting Instantiation Numbering of Master of Stability Control Device

| variable | meaning | remarks |
|---|---|---|
| master_no | instantiation numbering | used when |
| | of master of stability | subsequently |
| | control device | calling an interface |

3) Initialize a calculation unit of the device
Uint8 initDevice( );

### Definition of Function for Initializing Calculation Unit of Device

| variable | meaning | remarks |
|---|---|---|
| | return value: whether initialization | |
| | is successful | |
| | 0: fail in initialization | |
| | 1: succeed in initialization | |

4) Calculation interface
Uint8 trigDeviceCal(int cal_time);

### Definition of Calculation Interface Function

| variable | Meaning | remarks |
|---|---|---|
| int cal_time | single calculation time | the device is regarded |
| | (ms) | as a virtual terminal |
| | | for calculation |
| | return value: whether | |
| | initialization is successful | |
| | 0: fail in calculation | |
| | 1: succeed in calculation | |

5) Terminate calculating
Uint8 releaseDevice( )

### Definition of Calculation Termination Function

| variable | meaning | remarks |
|---|---|---|
| | return value: device releases memory | |
| | 0: fail in release | |
| | 1: succeed in release | |

Details of another embodiment of the method for constructing a power stability control simulation model according to the present disclosure are provided above, and details of the device for constructing a power stability control simulation model according to the present disclosure are provided below.

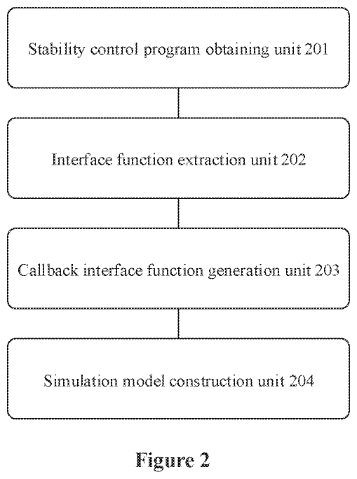

Referring to FIG. 2, the device for constructing a power stability control simulation model according to this embodiment includes a stability control program obtaining unit 201, an interface function extraction unit 202, a callback interface function generation unit 203, and a simulation model construction unit 204.

The stability control program obtaining unit 201 is configured to obtain a stability control device program of an actual stability control device.

The interface function extraction unit 202 is configured to extract an external interface function in the stability control device program.

The callback interface function generation unit 203 is configured to generate a callback interface function based on the external interface function, where the callback interface function is a callback function that takes the external interface function as a transfer parameter.

The simulation model construction unit 204 is configured to construct a power stability control simulation model based on the callback interface function in combination with a correspondence between the callback interface function and the external interface function, to implement simulation for a power system using the power stability control simulation model.

Furthermore, the external interface function includes an analog signal input/output interface, a digital signal input/output interface, and a communication channel data input/output interface.

Furthermore, the analog signal input/output interface includes: a master-slave communication analog signal input/output interface and an interstation communication analog signal input/output interface.

The digital signal input/output interface includes: a master-slave communication digital signal input/output interface and an interstation communication digital signal input/output interface.

The communication channel data input/output interface includes: a master-slave communication channel data input/output interface and an interstation communication channel data input/output interface.

Those skilled in the art can clearly understand that, for the convenience and conciseness of description, the operation processes of the terminals, devices and units may be with reference to the corresponding processes in the method embodiments, and are not described in detail here.

In the embodiments according to the present disclosure, it should be understood that the disclosed terminal, device and method may be implemented in other ways. For example, the device embodiments described above are only exemplary. For example, the units are divided only based on logical functions. The units may be divided in other ways in practice. For example, multiple units or components may be combined or integrated into another system, or some features may be disregarded or not implemented. In addition, the mutual coupling, direct coupling or communication connection shown or discussed may refer to an indirect coupling or communication connection via a certain interface, device or unit, and may be electrical, mechanical or of in other forms.

In the specification and the drawings of the present disclosure, the terms “first”, “second”, “third”, “fourth”, and the like (if existing) are intended to distinguish between similar objects rather than describe a specific sequence or a precedence order. It should be understood that the data used in this way may be interchanged in appropriate situations, so that the embodiments of the present disclosure may be implemented in order other than those illustrated or described herein. Moreover, the terms “include,” “comprise”, and any other variants thereof mean are intended to cover the non-exclusive inclusion. For example, a process, method, system, product, or device that includes a series of steps or units is not necessarily limited to those expressly listed steps or units, but may include other steps or units not expressly listed or inherent to such a process, method, product, or device.

The unit described as a separate component may be or may be not separated physically. The component displayed as a unit may be or may be not a physical unit, that is, may be located at a same place or may be distributed on multiple network units. Some or all of the units may be selected according to an actual requirement to achieve the objectives of the solutions in the embodiments.

In addition, all function units according to the embodiments of the present disclosure may be integrated into a same processing unit, or may be a physically separate unit, or two or more units are integrated into a same unit. The integrated units may be implemented in a form of hardware, or in a form of a software function unit.

In a case that the integrated unit is implemented in a form of a software functional unit, and is sold or used as an independent product, the integrated unit may be stored in a computer-readable storage medium. Based on such understanding, the essence of the technical solutions of the present disclosure, or parts of the technical solutions which contribute to the conventional technology, or all or parts of the technical solutions may be embodied in a form of a software product. The computer software product is stored in a storage medium, and includes several instructions which enable a computer device (such as a personal computer, a server, or a network device) to perform all or part of the method according to the embodiments of the present disclosure. The above-mentioned storage medium includes a U disk, a removable hard disk, a read-only memory (ROM), a random-access memory (RAM), a magnetic disk, an optical disk, or other media that can store program codes.

The above-mentioned embodiments are used for describing, instead of limiting the technical solutions of the present disclosure. Although the present disclosure is described in detail with reference to the above-mentioned embodiments, those skilled in the art should understand that, modifications can be made to the technical solutions described in the above-mentioned embodiments, or equivalent replacements can be made to some technical features in the technical solutions, and such modifications or replacements do not cause the essence of corresponding technical solutions to depart from the spirit and scope of the technical solutions of the embodiments of the present disclosure.

1. A method for constructing a power stability control simulation model, comprising:
obtaining a stability control device program of an actual stability control device;
extracting an external interface function in the stability control device program;
generating a callback interface function based on the external interface function, wherein the callback interface function is a callback function that takes the external interface function as a transfer parameter; and
constructing the power stability control simulation model based on the callback interface function in combination with a correspondence between the callback interface function and the external interface function, to implement simulation for a power system using the power stability control simulation model.

2. The method for constructing a power stability control simulation model according to claim 1, wherein the external interface function comprises an analog signal input/output interface, a digital signal input/output interface, and a communication channel data input/output interface.

3. The method for constructing a power stability control simulation model according to claim 2, wherein the analog signal input/output interface comprises: a master-slave communication analog signal input/output interface and an interstation communication analog signal input/output interface.

4. The method for constructing a power stability control simulation model according to claim 2, wherein the digital signal input/output interface comprises: a master-slave communication digital signal input/output interface and an interstation communication digital signal input/output interface.

5. The method for constructing a power stability control simulation model according to claim 2, wherein the communication channel data input/output interface comprises: a master-slave communication channel data input/output interface and an interstation communication channel data input/output interface.

6. A device for constructing a power stability control simulation model, comprising:
a processor; and
a memory having instructions stored thereon;
wherein the processor, when executing the instructions, is configured to:
obtain a stability control device program of an actual stability control device;
extract an external interface function in the stability control device program;
generate a callback interface function based on the external interface function, wherein the callback interface function is a callback function that takes the external interface function as a transfer parameter; and
construct the power stability control simulation model based on the callback interface function in combination with a correspondence between the callback interface function and the external interface function, to implement simulation for a power system using the power stability control simulation model.

7. The device for constructing a power stability control simulation model according to claim 6, wherein the external interface function comprises an analog signal input/output interface, a digital signal input/output interface, and a communication channel data input/output interface.

8. The device for constructing a power stability control simulation model according to claim 7, wherein
the analog signal input/output interface comprises: a master-slave communication analog signal input/output interface and an interstation communication analog signal input/output interface;
the digital signal input/output interface comprises: a master-slave communication digital signal input/output interface and an interstation communication digital signal input/output interface; and
the communication channel data input/output interface comprises: a master-slave communication channel data input/output interface and an interstation communication channel data input/output interface.

9. A power stability control simulation system, comprising an actual stability control device, an upper computer, and a simulation testing device, wherein
the actual stability control device, the upper computer, and the simulation testing device are sequentially in communication connection;
the upper computer comprises a device for constructing a power stability control simulation model; and
the simulation testing device is configured to communicate with a power stability control simulation model constructed by the upper computer to implement simulation for a power system,
wherein the device for constructing a power stability control simulation model comprises:
a processor; and
a memory having instructions stored thereon;
wherein the processor, when executing the instructions, is configured to:
obtain a stability control device program of the actual stability control device;
extract an external interface function in the stability control device program;
generate a callback interface function based on the external interface function, wherein the callback interface function is a callback function that takes the external interface function as a transfer parameter; and
construct the power stability control simulation model based on the callback interface function in combination with a correspondence between the callback interface function and the external interface function, to implement simulation for the power system using the power stability control simulation model.

10. The power stability control simulation system according to claim 9, wherein the simulation testing device comprises: a PSAPS simulation testing device or an RTDS simulation testing device.
